(19) United States
(12) Patent Application Publication
(10) Pub. No.: US 2026/0249526 A1
(43) Pub. Date: Aug. 27, 2026

(54) PROCESS FOR FORMING AN INSULATED REGISTER BOX IN WHICH THE REGISTER BOX HAS A IMPROVED R-VALUE

(71) Applicant: STERLING CUSTOM SHEET METAL, INC., Magnolia, TX (US)

(72) Inventor: Sterling Kidd COMBS, Magnolia, TX (US)

(21) Appl. No.: 19/061,487

(22) Filed: Feb. 24, 2025

(51) Int. Cl. B29C 44/12; B29K 75/00; B29K 105/04; F24F 13/02

(52) U.S. Cl. CPC B29C 44/1271; F24F 13/0245; F24F 13/0263; B29K 2075/00; B29K 2105/04; B29K 2995/0097

(57) ABSTRACT

A process for insulating a register box includes flowing an expandable closed cell polyurethane material at a temperature of 160° F. and 180° F. toward a plurality of side panels of the register box, placing the register box into or onto a support structure, introducing a liner over the flowed expandable closed cell polyurethane material within the register box, placing a form onto the liner in the register box so as to shape the expandable closed cell polyurethane material within the register box, and removing the form and the liner from the register box such that the solidified expandable closed cell polyurethane material resides against the plurality of side panels and against a wall that extends across a generally rectangular configuration of the register box. The insulated register box has an R-value of either six or eight with the same size and shape register box.

### CROSS-REFERENCE TO RELATED APPLICATIONS

Not applicable.

### FIELD OF THE INVENTION

The present invention relates to ductwork for heating, ventilation and air conditioning (HVAC) systems. More particularly, the present invention relates to register box is used in such systems. More particularly, the present invention relates to processes for providing insulation to the interior of such register boxes.

### BACKGROUND OF THE INVENTION

To create the desired ambient conditions within a structure, a typical HVAC system is installed for circulating and/or conditioning air drawn from the interior of the structure and returned to the interior of the structure. A central unit or several units are located in or near the structure, each unit comprising a fan for air circulation and optionally comprising a heating, humidification, or cooling system for conditioning the air passing through the central unit.

To conduct air to and from each central unit, ducting is provided in the structure. The ducting includes supply-air ducts which provide conditioned air to the interior of the structure and are connected to the outlets of each central unit and return-air ducts which return air to each central unit and are connected to inlets of each central unit. Supply-air ducts typically terminate in supply-air register boxes mounted to the walls, the ceilings, or other surfaces within the interior, whereas return-air ducts typically begin at register boxes mounted to a surface within the interior, such as a wall, ceiling, or floor. There are usually many more register boxes for supplying air than for returning air, with those for returning air typically being substantially larger than those for supplying air.

To increase efficiency, building codes are being revised to require substantially airtight HVAC systems. In the past, a standard technique has been utilized for forming such sheet-metal register boxes. A form is cut from a rectangular, planar metal sheet. The form has cutouts for corners or other features to allow bending of the form into the desired shape. Cutouts define the height of the sides and an overlapping flap is formed by cutting a slot at each cut out. The sides are bent along bend lines to lie in intersecting planes so as to form an open-bottom, rectangular enclosure of a register box, with the vertical edges of the sides abutting the inside surfaces of the sides. The flap is folded around each corner that lies adjacent the outer surface of the side and then fastened to the side with rivets. In order to complete the register box, a circular duct connector or is connected to a circular cutout in the upper surface of the box. Prior art register boxes are also formed with abutting edges to form the enclosure. The abutting or overlapping edges may be fastened by adhering or by other fastening means, such as spot welding.

The method described above produces ducting enclosures that often leak conditioned air through the gaps between the edges at the corners, or, in the case of enclosures formed with multiple pieces, through the seams where the pieces are joined together. The prior-art method includes many labor-intensive steps to form the enclosures, including the cutting of the planar sheet and the fastening of the edges.

In order to achieve the requisite efficiency in compliance with building codes, insulation is used with such register boxes. The formation of the insulation of the register boxes has become somewhat of a problem. Since the boxes are conventionally made of sheet metal, such as galvanized steel or aluminum, the insulation must be applied to either or both the inside and outside of the register box either before or after it is installed. The cutting and fastening of the insulation to the box is tedious and time-consuming. As such, it is thereby rather expensive in terms of the cost of the insulation material and in terms of the amount of time required to properly insulate the register box.

The placement of insulation can be a time-consuming, hazardous, and tedious task. Typically, a large section of fibrous material requires a cutting into various shapes that fit within the interior of the register box. This fibrous material is then affixed to the walls on the inside of the register box by hand. Often, many steps are required so as to properly fit the insulation material within the register box. Furthermore, since fibrous material is being manually handled by workers, there can be exposure to airborne fibers. The cutting and fitting of the insulation material within the register box is extremely tedious and boring to workers.

In the past, various patents have issued relating to register boxes and to the insulating of such register boxes. For example, U.S. Pat. No. 3,985,158, issued on Oct. 12, 1976 to J. V. Felter, describes a box for mounting diffusers wherein the main body of the box is made of expanded plastic or similar material. One or more connection elements are molded within the walls of the box to provide for connection of the box to the building structure and to a duct and also to reinforce the box.

U.S. Pat. No. 4,735,235, issued on Apr. 5, 1988 to Anderson et al., discloses an insulated duct end system. The system includes duct assemblies and transition components for interconnecting the duct assemblies. Each duct assembly includes an insulated duct having a rigid sleeve within at least one end. Each sleeve includes an abutment ring and orifices in the ring for permitting air to flow into the insulated area to balloon the layer and improve its insulative effect.

U.S. Pat. No. 5,095,942, issued on Mar. 17, 1992 to G. C. Murphy, teaches a plastic self-insulating ductwork system. The system includes a distribution box which includes an upper portion having a plurality of walls and a bottom plate. The distribution box is joined to interconnecting duct lines by adapter conduits. The adapter conduits are adapted at one end for connection to an opening in the wall and are adapted at the other end for connection to an adjoining duct line. U.S. Pat. No. 5,219,403, issued on Jun. 15, 1993 the G. C. Murphy, discloses a similar type of self-insulating ductwork system as that of U.S. Pat. No. 5,095,942.

U.S. Pat. No. 5,658,196, issued on Aug. 19, 1997 to D. L. Swaim, provides an air duct diffuser for attachment to a ceiling grid. The diffuser includes a frame which mounts to the ceiling grid and a louver which mounts to the frame for directing diffused air within an associated airspace. A pre-formed composite housing of insulating material mounts to the frame and has punch-out duct openings of varying sizes.

U.S. Pat. No. 5,749,190, issued on May 12, 1998 to S. R. Williams, shows an HVAC register box having no welded or riveted corners and also a process for making such an HVAC register box. The register box is fabricated from a single sheet of material without cutting. The register box has superior rigidity and resistance to air leakage at the joints or corners.

U.S. Pat. No. 5,957,506, issued on Sep. 28, 1999 to M. D. Stepp, provides a sheet-metal insulated register box. The register box has an adjustable elbow fitting that is coupled directly to an air inlet panel of an air distribution register box by having roll-formed flange portions that are mated in interlocking, overlapping engagement with each other. The air inlet panel includes an outwardly flared coupling flange bordering an air inlet opening. The neck of the sheet-metal elbow includes a folded coupling flange that is dimensioned for interfitting, overlapping engagement with the outwardly-flared elbow coupling flange.

U.S. Patent Publication No. 2008/0014860, published on Jan. 17, 2008 to Heitman et al., discloses a method and apparatus for eliminating register boxes. A collar plate assembly interfaces with metal air ducts and is provided with at least one spring indentation ring to accept two or more locking springs. The locking springs are used to attach the ceiling register to the collar plate assembly. The collar plate assembly uses mounting rails that attach the assembly to either the ceiling or wall supports. A trim ring is inserted in the cutout that attaches between the collar in the ceiling so as to eliminate air leakage and so as to provide an essentially smooth flow of air from the supply duct to the inside of the structure.

U.S. Patent Publication No. 2004/0130154, published on Jul. 8, 2004 to Stepp et al., shows a substantially airtight register box for HVAC systems. The register box has a body formed from at least one planar sheet. The body has an inlet and outlet. At least one of the inlet and the outlet is formed by folding corners of the planar sheet to form planar sides that lie in intersecting planes. The enclosure is then mounted to a surface of an interior area of a structure and is connected to ducts for communicating air between the interior area at a central air-handler unit.

U.S. Patent Publication No. 2008/0045137, published on Feb. 21, 2008 F. Rosal, discloses an insulated plenum box for heating, ventilating and air conditioning duct systems. This plenum box has insulation sprayed onto either the inside or outside of the plenum box in order to match the R-value of the connecting insulated duct.

The present Applicant is the owner of several patents related to such register boxes and the processes for forming such insulated register boxes. For example, U.S. Pat. No. 11,060,756, issued on Jul. 13, 2021 to the present Applicant, describes an insulated register box and process for forming the insulated register box. This register box has a body with a plurality of side walls arranged in a generally rectangular or square configuration and a plurality of flanges extending inwardly from the plurality of side walls. An expandable polymeric material is affixed to an inner side of each of the plurality of side wall such that the expandable polymeric material has a portion extending across one end of the body inwardly of the plurality of flanges. A sheet is positioned over the portion of the expandable polymeric material at one end of the body such that the sheet is interposed between the plurality of flanges and the portion of the expandable polymeric material. The expandable polymeric material and the sheet are cuttable so as to open to the interior of the register box.

U.S. Pat. No. 10,648,695, issued on May 12, 2020 to the present Applicant, describes a register box with a boot rail adapter that has an insulating material affixed within the register box, a guide rail affixed to a side panel of the register box, and a rail having a section received in a slot of the rail guide. The rail is adapted to be affixed to a supporting surface, such as a joist. The rail guide is slidable relative to the rail. The rail guide is affixed to an exterior surface of the side panel.

U.S. Pat. No. 10,309,682, issued on Jun. 4, 2019 to the present Applicant, teaches a process for insulating a register box in which the register box has a plurality of side panels arranged in a generally rectangular configuration and a duct opening through a wall that extends across the generally rectangular configuration. This process involves flowing an expandable polymeric material toward the plurality of side panels, placing the register box into or onto a support structure, introducing a liner over the flowed expandable polymeric material within the register box, and placing a form onto the liner in the register box so as to shape the expandable polymeric material within the register box. The form and the liner then removed from the register box.

U.S. Pat. No. 11,402,121, issued on Aug. 2, 2022 to the present Applicant, teaches an insulated register box apparatus with a boot rail adapter which has an insulating material affixed within the register box, a rail affixed to a side panel of the register box, and a rail guide having a slot that receives a section of the rail therein. The rail guide is adapted to be affixed to a supporting surface. The rail is affixed at least one of the side panels of the register box. The rail is slidable relative to the rail guide. The register box has a plurality of side panels and a duct that opens to an interior of the plurality of side panels. The insulating material extends inwardly of the plurality of side panels.

U.S. Pat. No. 10,995,969, issued on May 4, 2021 to the present Applicant, teaches an insulated register box for HVAC installations that has a body with a plurality of side panels arranged in a generally rectangular or square configuration and a wall extending across the rectangular configuration. A duct opens through the wall so as to communicate with an interior of the body. An expandable foamed polymeric material is affixed to an inner side of the side panels. The wall has a surface extending from the opening of the duct to the side panels. The expandable foamed polymeric material is affixed to the surface of the wall.

U.S. Pat. No. 9,951,969, issued on Apr. 24, 2018 to the present Applicant, describes an insulated register box and a method for forming such an insulated register box. The register box has a body with a plurality of side panels arranged in a generally rectangular or square configuration and a wall extending across the rectangular configuration. A duct opens through the wall so as to communicate with the interior of the body. An expandable foamed polymeric material is affixed to an inner side of the side panels. The wall has a surface extending from the opening of the duct to the side panels. The expandable foamed polymeric material is affixed to the surface of the wall.

The R-value is a measure of how well a two-dimensional barrier, such as a layer of insulation, resists the conductive flow of heat. R-value is the temperature difference per unit of heat flux needed to sustain one unit of heat flux between the warmer surface and the colder surface of a barrier under steady-state conditions. The measure is particularly relevant for lowering energy bills for heating in the winter or for cooling in the summer.

It is desirable for insulated register boxes to have an R-value of either six or eight. As such, if the R-value of six is specified, one type of insulated register box of a particular size is required. If an R-value of eight is specified, then a different register box of a different configuration is required. As such, in order to accommodate specifications requiring either an R-value of six or an R-value of eight, it is required that separate register boxes available. As such, there is a need to provide a register box that can accommodate request for either an R-value of six or an R-value of eight. There is also a need to provide these different R-value register boxes by using less foam and less metal for the register box. It is also important to be able to reduce the cost for providing such a register box.

Referring to FIG. 1, there is shown the insulated register box 10 formed in accordance with process of the prior art. The register box 10 includes a body 12 having side panels 14, 16, 18 and 20 formed into a generally rectangular configuration. A wall 22 extends across this generally rectangular configuration. A collar 24 is illustrated as affixed to the wall 22 so as to open to the interior of the body 12. The collar 24 includes an open end 26 so as to allow collar 24 to be connected to the HVAC system of a building. As will be described hereinafter, an expandable polymeric material, such as polyurethane, is applied for the purposes of insulating the interior of the body 12.

FIG. 2 shows a side view of the register box 10. As can be seen in FIG. 2, the side panel 14 is particularly illustrated. The collar 24 is illustrated as affixed to and extending outwardly of the wall 22. There is a lip 44 that extends outwardly of the end 46 of the body 12. The lip 44, as will be described hereinafter, extends outwardly of a flange 48. Flange 48 extends inwardly from the side panels 14, 16, 18 and 20 such that the inner edges define an aperture 50 opening to the interior of the body 12.

FIG. 3 is an end view of the register box 10 of the prior art. The collar 24 is affixed to the wall 22. Wall 22 includes a surface 52 that extends from the opening of the collar 24 to the side panels 14, 16, 18 and 20 of the body 12. In FIG. 3, it can be seen that the expanded polymeric material 60 resides over the surface 52 and extends to the side panels 14, 16, 18 and 20. As such, the expanded polymeric material 90 effectively insulates the wall 22 in the area adjacent to the opening of the collar 24.

FIG. 3 further shows the nature of the flanges 48. Flange 48 is illustrated as extending around the interior of the body 12. Flange 48 has a particular width. The expanded polymeric material 60 will reside against the side panels 14, 16, 18 and 20 and will have a thickness approximately equal to the width of the flanges 48. The lip 50 is illustrated as extending in transverse relationship from the flange 48.

FIG. 4 is a cross-sectional view of the register box 10. The expanded polymeric material 60 is illustrated as positioned against the side panels 14 and 18. A similar configuration, such as shown in FIG. 4, will occur with respect to the side panels 16 and 20. The expanded polymeric material 60 has a thickness approximately equal to the width dimension of the flange 48. The flange 48, along with the lip 50, defines an aperture 64 that opens to the interior of the body 12. The expanded polymeric material 60 also has a portion 60 that resides against the inner surface of the wall 22. This portion 60 extends from the side panels 14 and 18 so as to generally be aligned with the opening of the collar 24.

In this configuration, the expanded polymeric material 60 can serve as insulation. This insulation is compliant with national building codes, is fire resistant, and also avoids the use of fibrous material. As such, this type of material, since it avoids fibrous material, improves the health and safety of workers that assemble the register box 10. The insulation created by the expanded polymeric material 60 does not require any alterations in the structure of the body 12 or of the duct 24. The insulation material causes the register box 10 to be very energy efficient. Also, since the expanded polymeric material 60 enters and emerges through the various openings, gaps, seams, and holes in the register box 10, it minimizes air loss and improves inspectability.

In FIG. 4, it can be seen that there is no expanded polymeric material located on the inner wall 68 of the collar 24. If any expanded polymeric material would enter the collar 24 or reside on the inner wall 68 of the collar 24, then it could hamper air circulation. As such, it was felt that it was important to block any movement of the expanded polymeric material from entering the area on the interior of the collar 24. Since the expanded polymeric material 60 extends to the aperture 64 that is defined by the lips 50 and the flanges 48, it does not interfere with air flow into the interior of the register box.

FIG. 5 illustrates a step in the forming of the register box of the type shown in FIGS. 1-4. FIG. 5, in particular, is shown in U.S. Pat. No. 10,309,682 to the present applicant. The various prior art patents to the present applicant show various other processes that can be utilized so as to form the insulated register box. FIG. 5 is simply an example of how the expandable polymeric material, such as polyurethane, can be introduced into a mold so as to form the insulation within the register box. In FIG. 5, it can be seen that there is a supply 102 of the expandable polymeric material. The expandable polymeric material is polyurethane. A conduit 104 extends from the supply 102 to a foam gun 106. As such, the foam gun 106 can inject foamed expandable polymeric material 108 toward the interior of the register box. This foam gun will inject such foamed expandable polymeric material at a temperature of 140°. Heretodate, this has been considered the optimal temperature in which to introduce such foamed expandable polymeric material into the register box. As such, the foamed expandable polymeric material will solidify against the plurality of side panels and against the wall in order to form the proper insulation for the register box.

In FIG. 5, it can be seen that the register box 110 includes a plurality of side panels 112 arranged in a generally rectangular configuration of the type described hereinbefore. There is a collar 114 that opens through a wall 116 that extends across the generally rectangular configuration of the plurality of panels 112. The foamed expandable polymeric material is flowed generally toward the wall 116 and also around the plurality of side panels 112. The register box 110 is maintained and moved at an angle so as to allow a person operating the foam gun 106 to direct the foamed expandable polymeric material 108 generally around the interior of the plurality of side panels and also the portions of the wall 116 away from the opening of the collar 114.

A support structure 118 is illustrated is located below the register box 110. The support structure 118 is a frame that has sides 112 and an interior 122. After the foamed expandable polymeric material is directed generally around the side panels 112 and the wall 116, the collar 114 can be introduced into the interior 122 of the support structure 118. The portions of the wall 116 that extend outwardly of the collar 114 will reside on the top surface 124 of the support structure 118.

In FIG. 6, it can be seen that the support structure 118 is placed upon an underlying surface 126. The support structure 126 can be a carousel. The collar 114 is illustrated as positioned within the interior 122 of the support structure 118. The wall 116 will reside on the top 124 of the support structure 118. In FIG. 6, the foamed expandable polymeric material 108 is illustrated as residing against the plurality of side panels 112 and also against the wall 116. The register box 110 has flanges 128 that extend inwardly from the plurality of side panels 112. Flanges 128 will extend inwardly from an end of the side panels 112 opposite the wall 116. The flanges 128 will define an aperture of the register box.

With reference to FIG. 6, after the foamed expandable polymeric material 108 has been introduced into the interior of the register box 110, a liner 130 is placed over the expandable polymeric material. The liner 130 will include edges 132 which extend outwardly of the register box 110. As such, these edges 132 can provide a grasping surface. A form 134 is then placed upon the liner 130 and into the interior of the register box 110. The form 134 is a metal plug which has a diameter greater than a diameter of the collar 114. As such, the bottom of the mold 134 will extend beyond the diameter of the duct 114. The form 134 is intended to shape the insulation of the register box 110. As such, it will have a shape that corresponds to the intended shape of the insulation on the interior of the register box 110. As described herein, the liner 130 can be a plastic sheet or it can be a surface that is formed on the form 134. The purpose of the liner 130 is to allow the separation of the form 134 from the solidified expanded polymeric material 108.

An adjustable hold-down 136 is maintained by a support 138. Adjustable hold-down 136 serves to secure the register box 110 on the support structure 118 and also to maintain the register box 110 and the support structure 118 upon the underlying surface 126. A lid 140 is illustrated as extending upwardly from a member 142. The lid 140 is connected to the member 142 by a hinge 144. Member 142 extends upwardly from the underlying surface 126 in proximity to one of the panels 112 of the register box 110. A latch 146 is located adjacent to an opposite side of the register box 110. Latch 146, as will be described hereinafter, serves to receive the end 148 of the lid 140 so as to lock the lid 148 in positioned over the form 134 and over the top of the register box 110.

FIG. 7 shows that the lid 140 is pivoted downwardly about the hinge 144 so as to be juxtaposed against the top of the form 134. The end 148 is locked in position by the latch 146. Importantly, in this configuration, the lid 140 provides resistance against the expansion of the expandable polymeric material 108 within the register box 110. As such, the expandable polymeric material 108 (at 140° F.) can properly solidify in a desired configuration within the interior of the register box 110. This is important since polyurethane has generally irregular expansion characteristics. The lid 140 will confine this expansion of the expandable polymeric material 108 to the shape that is desired so as to form the installation of the register box 110.

After the expandable polymeric material 108 has solidified, the lid 140 can be pivoted upwardly and unlatched from latch 146. With reference to FIG. 6, the outwardly extending edges 132 can be grasped and lifted upwardly so as to remove the form 134 from the interior of the register box 110. The solidified polymeric material 108 will have the desired shape and configuration shown in FIGS. 1-4. Ultimately, the adjustable hold-down 136 can be moved away from the register box 110 so as to allow the register box 110 to be lifted upwardly and removed from the support structure 118. As such, a properly formed register box is achieved. As was described hereinbefore, the solidified expandable polymeric material 108 will have a thickness at the side panels 112 generally equal to the width of the flange 128. Similarly, the expandable polymeric material 108 will have a suitable thickness extending upwardly from the wall 116. The expandable polymeric material 108 will leave the collar 114 exposed.

FIG. 8 illustrates a register box 200 that had been manufactured in accordance with the prior art. Register box 200 includes side panels 202 and 204. A wall 206 extends across the generally rectangular configuration of the plurality of side panels 202 and 204. A collar 208 extends through the wall 206 so as to have an opening 210 opening to the interior 212 of the register box 200.

As can be seen in FIG. 8, the expandable polymeric insulation 214 has been applied to the plurality of side panels 202 and 204 and also to the wall 206. FIG. 8, in particular, shows the insulation requirements in order for the register box 200 to achieve an R-value of six. As can be seen, the expandable polymeric insulation 214 that is applied to the side panels 202 and 204 will have a width at the flange 216 of one inch. The expandable polymeric insulation 214 will continue to taper outwardly toward the wall 216. The insulation 218 that resides against the wall 206 will have a thickness of 1.25 inches. The portion of the expandable polymeric insulation 220 opposite the flange 216 will have a thickness of 1.25 inches.

As such, in order to achieve the requisite R-value of six, while maintaining the proper flow characteristics associated with the collar 208 and the interior 212 of the register box 200, the expandable polymeric insulation 214 is required to have these characteristics. This is particularly true when the expandable polymeric material is introduced at the requisite temperature of 140° F. As can be seen, expandable polymeric insulation 214 occupies a great deal of space within the interior of the register box 200. As a result, the interior 212 of the register box 200 is significantly reduced in size and the flow of air is reduced when the register box is installed.

FIG. 9 shows the register box 300 as formed in order to achieve an R-value of eight. Register box 300 includes a plurality of side panels 302 and a wall 304. An inwardly extending flange 306 extends from each of the side panels 302 and 308. A lip 310 will extend outwardly from each of the flanges 306. The collar 312 will extend through the wall 304 so as to have an opening 314 to the interior 316 of the insulated register box 300.

In FIG. 9, it can be seen that the expandable polymeric insulation 318 is applied in an amount substantially greater than that shown in FIG. 8. This is because, in order to achieve a higher R-value, more insulation is required. As such, the expandable polymeric insulation 318 will have a thickness at the flange 306 of 1.5 inches and a thickness at the wall 304 of 1.625 inches. The expandable polymeric insulation 318 will have a width of 1.625 inches at the opening 314 of the collar 312.

It can be seen in FIG. 9 that this large amount of insulation 318 will greatly restrict the volume of the interior 316. In order to provide the requisite volume for the transmission of air, the size of the register box 300 will need to be expanded in order to accommodate the large amount of insulation required in the interior of the register box 300. As such, with reference to FIGS. 8 and 9, the register box 200 and the register box 300 must be of different sizes. This requires the manufacturer to maintain supplies of the smaller size register box 200 and the larger size register box 300 in stock prior to the application of the insulation. It can be seen that the amount of insulation required for each of the register boxes 200 and 300 is quite significant. As such, a need is developed so as to reduce the amount of insulation material that is required for the creation of the register box and reduce the amount of metal material, such as aluminum, used for the formation of the register boxes.

It is an object of the present invention to provide a process for forming an insulated register box that requires less polymeric insulation.

It is another object of the present invention to provide a process for forming an insulated register box requires less metal material.

It is another object of the present invention to provide a process for forming an insulated register box that avoids the need for the storage of different sizes of register box.

It is a further object of the present invention to provide a process for forming an insulated register box that is less costly.

It is still another object of the present invention to provide a process for forming an insulated register box that meets the R-value insulation requirements.

It is a still further object of the present invention to provide an insulated register box that allows air to escape in order to reduce the size of the closed cells for the expandable polymeric material used as the insulation.

These and other objects and advantages of the present invention will become apparent from a reading of the attached specification and appended claims.

### SUMMARY OF THE INVENTION

The present invention is a process for insulating the register box that includes the steps of: (1) flowing an expandable polymeric material at a temperature between 160° F. and 180° F. toward a plurality of side panels of the register box; (2) placing the register box into or onto a support structure; (3) introducing a liner over the flowed expandable polymeric material within the register box; (4) placing a form on the liner in the register box so as to shape the expandable polymeric material within the register box; and (5) removing the form and the liner from the register box such that the solidified expandable polymeric material resides against the plurality of side panels and against the wall.

In the preferred embodiment of the present invention, the expandable polymeric material is a closed cell polyurethane material.

In an embodiment of the present invention, the register box will have an R-value of six. The solidified expandable polymeric material against the plurality of side panels has a thickness of approximately one inch. The solidified expandable polymeric material against the wall will have a thickness of approximately one inch. The solidified expandable polymeric material at the plurality of side panels has a surface extending entirely in parallel relation to each of the plurality of side panels.

In an alternative embodiment of the present invention, the register box has a R-value of eight. The solidified expandable polymeric material against the plurality of side panels has a thickness of between one inch and one and one-quarter inches. The solidified expandable polymeric material against the wall will have a thickness of approximately one and one-quarter inches. The solidified expandable polymeric material has a thickness of approximately one inch against the flange opposite the wall and tapers so as to have a thickness of one and one-quarter inches adjacent the wall.

The method of the present invention further includes forming at least one exhaust port in an area adjacent the wall, and exhausting air through this exhaust port as the expandable polymeric material expands and solidifies. The method of the present invention further includes flowing the expandable polymeric material toward the wall and solidifying the expandable polymeric material around an exterior of a portion of the collar that extends through the wall. The step of placing the form includes placing the form onto the liner in the register box. The form has a constant width that defines a surface in the solidified expandable polymeric material that has a constant thickness The step of placing, in the alternative embodiment, includes placing a form onto the liner in the register box such that the form has a tapered width that defines a surface in the solidified expandable polymeric material that has a tapered thickness.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is an upper perspective view showing the register box in accordance with the prior art.

FIG. 2 is a side elevational view showing the register box in accordance with the prior art.

FIG. 3 is a bottom view showing the register box in accordance with the prior art.

FIG. 4 is a cross-sectional view showing the register box in accordance with the prior art.

FIG. 5 is a diagrammatic view showing an initial step in the formation of the insulated register box of the prior art.

FIG. 6 is a cross-sectional view showing a further step in the process of forming the insulated register box of the prior art.

FIG. 7 is a cross-sectional view showing a further step in the formation of the insulated register box in accordance with the prior art.

FIG. 8 is a cross-sectional view showing the configuration of the expandable polymeric material within the register box of the prior art in which the register box has an R-value of six.

FIG. 9 is a cross-sectional view of a register box of the prior art in which showing, in particular, the expandable polymeric material used to achieve an R-value of eight.

FIG. 10 is a cross-sectional view showing the register box formed in accordance with the method of the present invention in which the register box has an R-value of six.

FIG. 11 is a cross-sectional view of a register box of the present invention in which the register box has an R-value of eight.

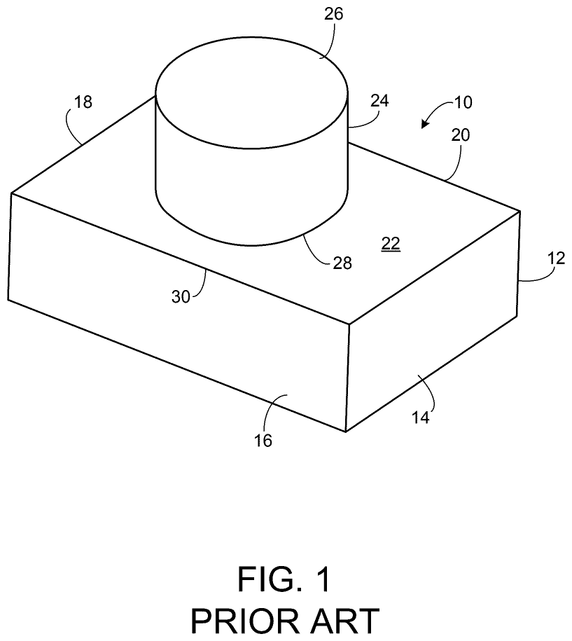

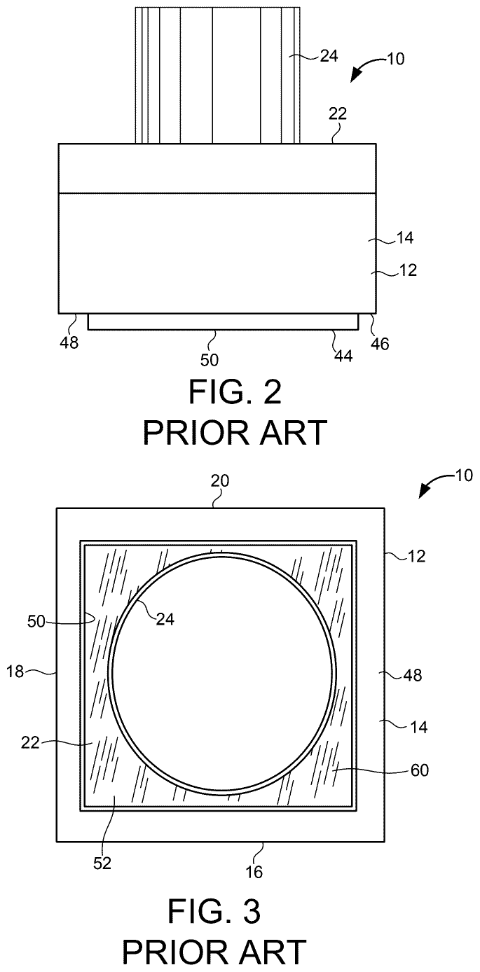

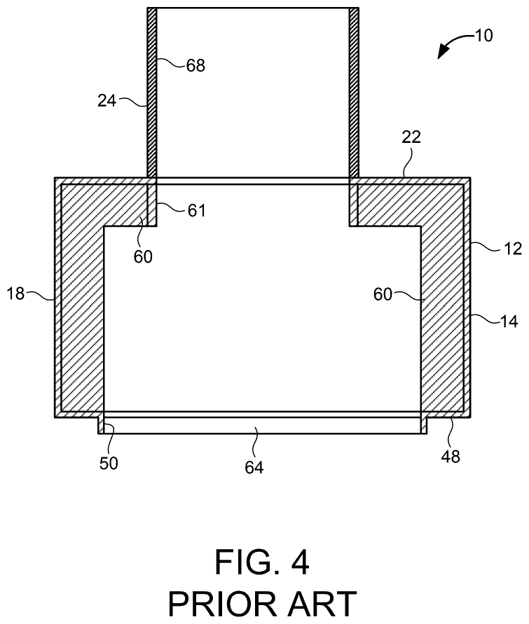

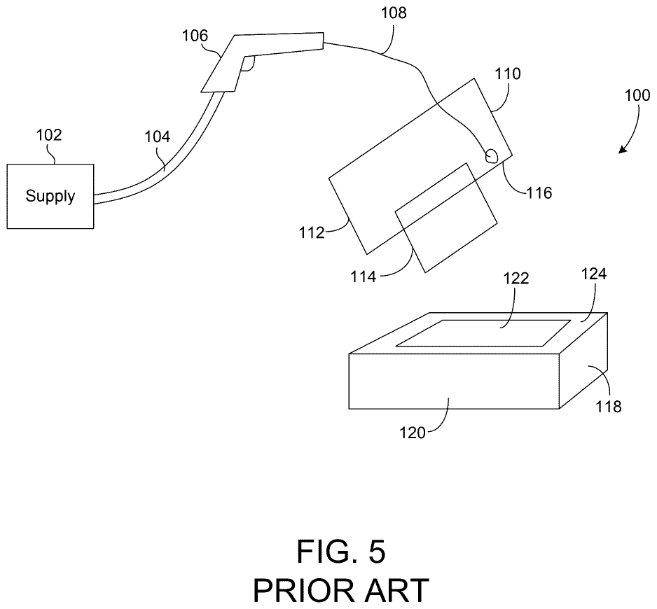

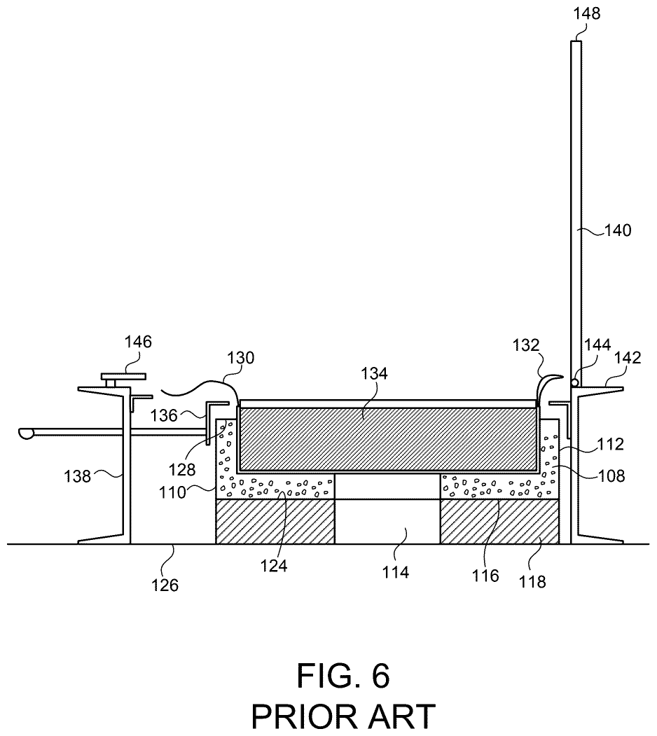

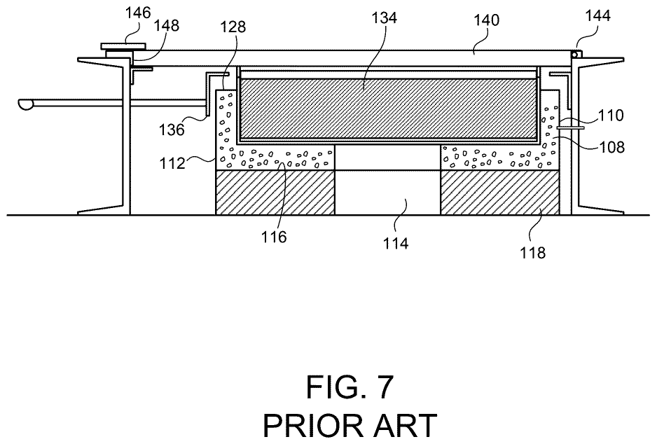

### DETAILED DESCRIPTION OF THE INVENTION

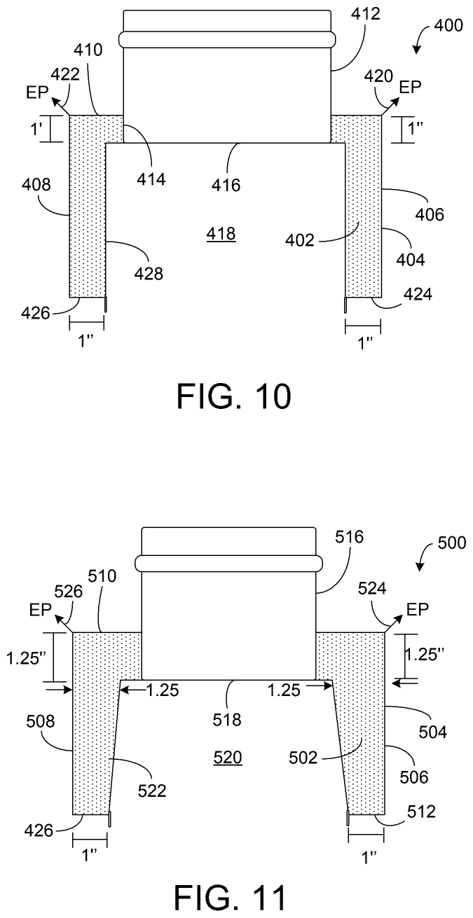

Referring to FIG. 10, there is shown a register box 400 that has been formed in accordance with the teachings of the present invention. In particular, and as background, experiments with the installation of the expandable polymeric material 402 within the interior of the housing 404 of the register box 400 have shown that the foaming temperature of 140° F. was, surprisingly, not optimal. After experimentation was conducted with respect to the temperature of the expandable polymeric material being 160° F. to 180° F., it was found that this temperature used for the installation of the expandable polymeric material (in the manner of the previous of a installation of the expandable polymeric material formally enhance the qualities of the register box 400. In particular, it is found that it made smaller cells and a larger amount of the closed cells. As such, less foam was required in order to achieve a higher R-value. In order to reduce the foam requirements for the creation of the register box 400 in order to achieve an R-value of six, the process of the present invention requires the application of the insulating polymeric foam material 402 against the side walls 406 and 408 of the generally rectangular configuration of the housing 404 of the register box 400. The expandable polymeric foam insulating material 402 is also applied against the wall 410. It can be seen that the collar 412 has a portion 414 that extends through the wall 410 so as to have an opening 416 to the interior 418 of the register box 400. Exhaust ports 420 and 422 are formed adjacent to the wall 410 so as to allow air to exhaust during the solidification of the expandable polymeric material against the side panels 406 and 408 and against the end wall 410. The expandable polymeric material 402 will also reside against a portion of the outer diameter of the collar 412 so as to provide insulating qualities therewith.

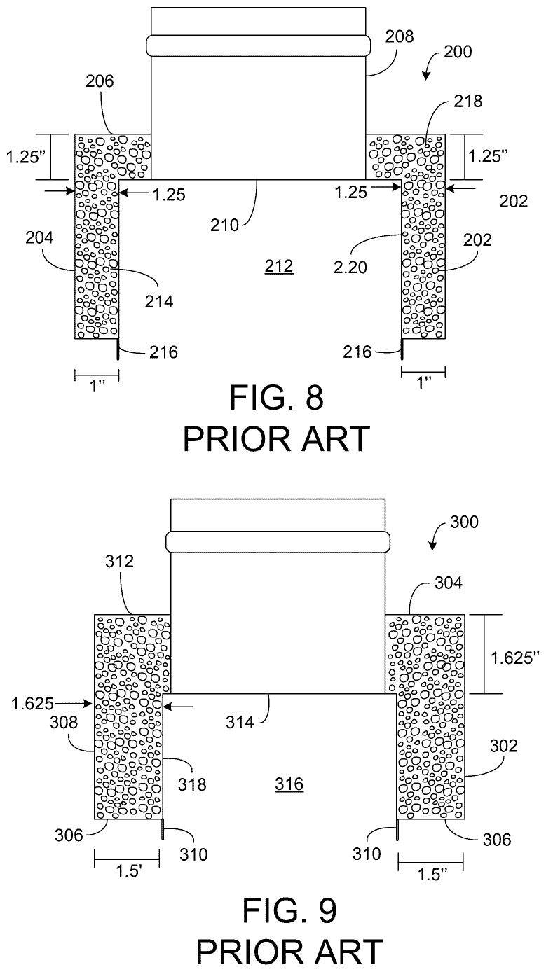

Importantly, since the expandable polymeric material is introduced at a temperature between 160° F. and 180° F., the amount of the expandable polymeric foam material 402 is substantially less than the related structure shown in FIG. 8. In particular, the expandable polymeric foam material 402 at the flanges 424 and 426 will have a thickness of approximately one inch. The amount of the expandable polymeric material at the wall 410 will also have a thickness of approximately one inch. The surface 428 of the expandable polymeric foam material will be in parallel relation to the respective side panels 406 and 408 and will be untaped and of constant thickness. As such, the expandable polymeric material 402 away from the flanges 424 and 426 will also have a thickness of one inch. It is believed that the use of the exhaust ports 420 and 422, in synergism with the increased temperature of 160° F. and 180° F., enhances the ability for the expandable polymeric foam material to achieve an R-value of six with less foam. This is believed to be the result of creating smaller and closed cells and a larger number of such closed cells. The evacuation of the air allows for the polyurethane material used for the creation of the insulating material 402 to properly evacuate air from the register box 400.

FIG. 10 illustrates the insulated register box 500 that is used for achieving an R-value of eight. The housing 504 of the insulated register box 500 will have dimensions identical to the dimensions of the housing 404 of the insulated register box 400. The expandable polymeric insulating material 502 will have different dimensions in order to achieve this higher R-value.

In particular, it can be seen in FIG. 11 that the housing 504 includes side panels 506 and 508, along with end wall 510, in the nature of the housing 404 of the insulated register box 400, as shown in FIG. 10. In order to achieve the R-value of eight, the insulated polymeric material will have a thickness of one inch adjacent to the flange is 512 and 514. The expandable polymeric material 502 at the wall 510 will have a thickness of 1.25 inches. The expandable polymeric material 502 will taper inwardly and increase in thickness from the flanges 512 and 514 toward the wall 510.

The collar 516 is illustrated as extending through the wall 510 so as to have an opening 518 that opens to the interior 520 of the insulated register box 500. The expandable polymeric material 502 will have a thickness of 1.25 inches in the area away from the flanges 512 and 514. As such, the inner surface 522 of the expandable polymeric insulating material 502 will taper inwardly away from the side panels 506 and 508. Exhaust ports 524 and 526 allow air to evacuate from the interior of the insulated register box as the expandable polymeric material solidifies.

It is important to realize that the thermal manipulation of the expandable polymeric material is used to adjust the R-value in the insulated register boxes. By raising this temperature from 140° F. to 160° to 180° F., the present invention achieves as R-value of six with a one inch thickness wall. This is a 20% increase in R-value in a material savings of 20% by being able to get a greater R-value out of less material and thickness. The present invention makes it possible to form a smaller, more economical product that uses less metal and polymeric material than the prior art.

The present invention is also able to keep the dimensions of the larger register box inside the ceiling joist dimensions. This has been problematic due to a 1×1″ dimensional savings in the present invention. The creation of the higher R-value allows it possible to create the eight R-value register with the same dimensions as the six R-value register. Once again, this saves 20% of the material used for the register box. Since it is possible to manipulate the R-value with temperature, it is not necessary to produce different size registers. The same equipment lines can be run without die changeovers. This speeds up production and streamlines orders. The ability to present a higher R-value with a smaller thickness will also speed up cure times. The higher temperatures also cause the foaming fill time to be 50% faster. This allows for faster processing of a register. The higher R-values also provide an economical and superior product to the ever-increasing building code demands for a higher R-values.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A process for insulating a register box, the register box having a plurality of side panels arranged in a generally rectangular configuration and a collar opening through a wall, the wall extending across the generally rectangular configuration, the process comprising:
flowing an expandable polymeric material at a temperature between 160° F. and 180° F. toward the plurality of side panels;
placing the register box into or onto a support structure;
introducing a liner over the flowed expandable polymeric material within the register box;
placing a form onto the liner in the register box so as to shape the expandable polymeric material within the register box; and
removing the form and the liner from the register box such that the solidified expandable polymeric material resides against the plurality of side panels and against the wall.

2. The process of claim 1, wherein the expandable polymeric material is a closed cell polyurethane.

3. The process of claim 2, wherein the register box has an R-value of six, the solidified expandable polymeric material against the plurality of side panels has a thickness of approximately one inch.

4. The process of claim 3, wherein the solidified expandable polymeric material against the wall has a thickness of approximately one inch.

5. The process of claim 4, wherein the solidified expandable polymeric material against the plurality of side panels has a surface extending entirely in parallel relation to each of the plurality of side panels.

6. The process of claim 2, wherein the register box has an R-value of eight, the solidified expandable polymeric material against the plurality of side panels having a thickness of between one inch and one and one-quarter inches.

7. The process of claim 6, wherein the solidified expandable polymeric material against the wall has a thickness of approximately one and one-quarter inches.

8. The process of claim 6, wherein the solidified expandable polymeric material has a thickness of approximately one inch against a flange opposite the wall and tapers so to have a thickness of approximately one and one-quarter inches adjacent to the wall.

9. The process of claim 1, further comprising:
forming at least one exhaust port in an area adjacent the wall; and
exhausting air through the at least one exhaust port as the expandable polymeric material expands and solidifies.

10. The process of claim 1, further comprising:
flowing the expandable polymeric material toward the wall; and
solidifying the expandable polymeric material around an exterior of a portion of the collar that extends through the wall.

11. The process of claim 3, wherein the step of placing a form comprising:
placing the form onto the liner within the register box, the form having a constant width that defines a surface in the solidified expandable polymeric material that has a constant thickness.

12. The process of claim 6, wherein the step of placing a form comprising:
placing the form onto the liner in the register box, the form having a tapered width that defines a surface in these solidified expandable polymeric material that has a tapered thickness.

13. A process for insulating a register box such that the register box has an R-value of six, register box having a plurality of side panels arranged in a generally rectangular configuration and a collar opening through a wall, the wall extending across the generally rectangular configuration, the process comprising:
flowing an expandable closed cell polyurethane material with a temperature of between 160° F. and 180° F. toward the plurality of side panels;
placing the register box into or onto a support structure;
introducing a liner over the flowed expandable closed cell polyurethane material within the register box;
placing a form onto the liner in the register box so as to shape the expandable closed cell polyurethane material within the register box; and
removing the form and the liner from the register box such that the solidified expandable closed cell polyurethane material resides against the plurality of side panels and against the wall, the solidified expandable closed cell polyurethane material against the plurality of side panels having a thickness of approximately one inch.

14. The process of claim 13, wherein the solidified expandable closed cell polyurethane material against the wall has a thickness of approximately one inch.

15. The process of claim 14, wherein the solidified expandable closed cell polyurethane material against the plurality of side panels has a surface extending entirely in parallel relation to each of the plurality of side panels.

16. The process of claim 1, further comprising:
forming at least one exhaust port in an area adjacent to the wall; and
exhausting air through the at least one exhaust port as the expandable closed cell polyurethane material expands and solidifies.

17. A process for insulating a register box such as the register box has an R-value of eight, the register box having a plurality of side panels arranged in a generally rectangular configuration and a collar opening through the wall, the wall extending across the generally rectangular configuration, the process comprising:
flowing an expandable closed cell polyurethane material at a temperature 160° F. and 180° F. toward the plurality of side panels;
placing the register box into or onto a support structure;
introducing a liner over the flowed expandable closed cell polyurethane material within the register box;
placing a form onto the liner in the register box so as to shape the expandable closed cell polyurethane material within the register box; and
removing the form and the liner from the register box such as the solidified expandable polyurethane material resides against the plurality of side panels and against the wall.

18. The process of claim 17, wherein the solidified expandable closed cell polyurethane material against the wall has a thickness of approximately one and one quarter inches.

19. The process of claim 18, wherein the solidified expandable closed cell polyurethane material has a thickness of approximately one inch against a flange opposite the wall and taper so as to have a thickness of approximately one and one quarter inches adjacent to the wall.

20. The process of claim 17, further comprising:
forming at least one exhaust port in an area adjacent to the wall; and
exhausting air through the at least one exhaust port as the expandable closed cell polyurethane material expands and solidifies.
